(19) United States
(12) Patent Application Publication
(10) Pub. No.: US 2010/0145796 A1
(43) Pub. Date: Jun. 10, 2010

(54) SYSTEM AND APPARATUS FOR INTERACTIVE PRODUCT PLACEMENT

(76) Inventors: James David Berry, Chicago, IL (US); Radd Paul Berkheiser, Chicago, IL (US)

Correspondence Address: PATENT INGENUITY, PC, 520 BROADWAY, SUITE 350, SANTA MONICA, CA, 90401, US

(21) Appl. No.: 12/328,706

(22) Filed: Dec. 4, 2008

(51) Int. Cl. G06Q 30/00; G06F 3/048; G06F 15/16; G06F 3/00

(52) U.S. Cl. 705/14.49; 715/767; 709/224; 715/760; 715/862; 705/26; 705/27

(57) ABSTRACT

A system is provided. The system includes a media server that provides a media file to a computing device. Further, the system includes a metadata server that provides metadata corresponding to the media file to the computing device. The metadata includes (i) a plurality of x and y coordinates that indicate an interactive region of a display of the media file at a predetermined time and (ii) an instruction that is automatically triggered upon user interaction within the interactive region of the display of the media file. The interactive region includes an interactive region unique identifier. In addition, the system includes an interaction tracking server that receives interaction data and the interactive region unique identifier from the computing device. The interaction data including data corresponds to user interaction in the interactive region of the display of the media file.

### BACKGROUND

1. Field

This disclosure generally relates to the field of media. More particularly, the disclosure relates to interactive media.

2. General Background

The Internet has helped increase the ability to search for different products. However, advertising methods and technology have not been effectively developed to market the full extent of products offered on the Internet or other sales channels.

### SUMMARY

In one aspect of the disclosure, a system is provided. The system includes a media server that provides a media file to a computing device. Further, the system includes a metadata server that provides metadata corresponding to the media file to the computing device. The metadata includes (i) a plurality of x and y coordinates that indicate an interactive region of a display of the media file at a predetermined time and (ii) an instruction that is automatically triggered upon user interaction within the interactive region of the display of the media file. The interactive region includes an interactive region unique identifier. In addition, the system includes an interaction tracking server that receives interaction data and the interactive region unique identifier from the computing device. The interaction data including data corresponds to user interaction in the interactive region of the display of the media file.

In another aspect of the disclosure, a system is provided. The system includes a media server that provides a media file to a computing device. Further, the system includes a metadata server that provides metadata corresponding to the media file to the computing device. The metadata includes (i) a plurality of x and y coordinates that indicate an interactive region of a display of the media file at a predetermined time and (ii) a plurality of instructions that are automatically triggered upon user interaction within the interactive region of the display of the media file, the interactive region including a unique identifier.

In yet another aspect of the disclosure, an apparatus is provided. The apparatus includes a media file reception module that receives a media file. Further, the apparatus includes a metadata reception module that receives metadata corresponding to the media file to the computing device. The metadata includes (i) a plurality of x and y coordinates that indicate an interactive region of a display of the media file at a predetermined time and (ii) an instruction that is automatically triggered upon user interaction within the interactive region of the display of the media file. The interactive region includes an interactive region unique identifier. Further, the apparatus includes a display module that provides a display of the media file and the interactive region in the display of the media file at the plurality of x and y coordinates. In addition, the apparatus includes an interactive region monitoring module that monitors the interactive region in the display of the media file at the plurality of x and y coordinates. The apparatus also includes an interaction data transmission module that transmits interaction data and the interactive region unique identifier to an interaction tracking server. The interaction data including data corresponds to user interaction in the interactive region of the display of the media file.

In another aspect of the disclosure, an apparatus is provided. The apparatus includes a media file reception module that receives a media file. Further, the apparatus includes a metadata reception module that receives metadata corresponding to the media file to the computing device, the metadata including (i) a plurality of x and y coordinates that indicate an interactive region of a display of the media file at a predetermined time and (ii) an instruction that is automatically triggered upon user interaction within the interactive region of the display of the media file. The interactive region includes an interactive region unique identifier. In addition, the apparatus includes a display module that provides a display of the media file and the interactive region in the display of the media file at the plurality of x and y coordinates. Finally, the display module includes an interactive region monitoring module that monitors the interactive region in the display of the media file at the plurality of x and y coordinates.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an interactive product placement configuration.

FIG. 2 illustrates a block diagram of the user computing device.

FIG. 3A illustrates the interactive display with a menu of available products in the display at a particular time.

FIG. 3B illustrates the interactive display with a sound window.

FIG. 3C illustrates the interactive display with an interactive region.

FIG. 3D illustrates the interactive display with another interactive region.

FIG. 3E illustrates the interactive display with another interactive region.

FIG. 3F illustrates the interactive display with another interactive region.

FIG. 4 illustrates a process that may be utilized to provide interactive tracking.

FIG. 5 illustrates a process that may be utilized to provide interactive tracking.

### DETAILED DESCRIPTION

A system and apparatus are disclosed for interactive product placement. In one embodiment, a user is able to interact with a video to purchase products in that video. For example, a user may be watching his or her favorite television show on his or her computer and see that the lead actor is wearing a shirt of interest. The user may then move his or her mouse cursor over the shirt to obtain information about the shirt. For instance, the user may be able to find out the designer of the shirt and a web site or retailer at which the shirt may be purchased. The user may then select a link to the web site at which the shirt may be purchased.

The system and apparatus may be utilized with any type of computing device. For example, a computer, Digital Video Recorder (“DVR”), Digital Video Disc (“DVD”) player, cell phone, personal media player (“PMP”), Set Top Box (“STB”), Gaming Console, etc. may be utilized. Further, a television through a remote control or other input device, video screen inside a car, or any other device that is capable of displaying a video and registering viewer input may be utilized.

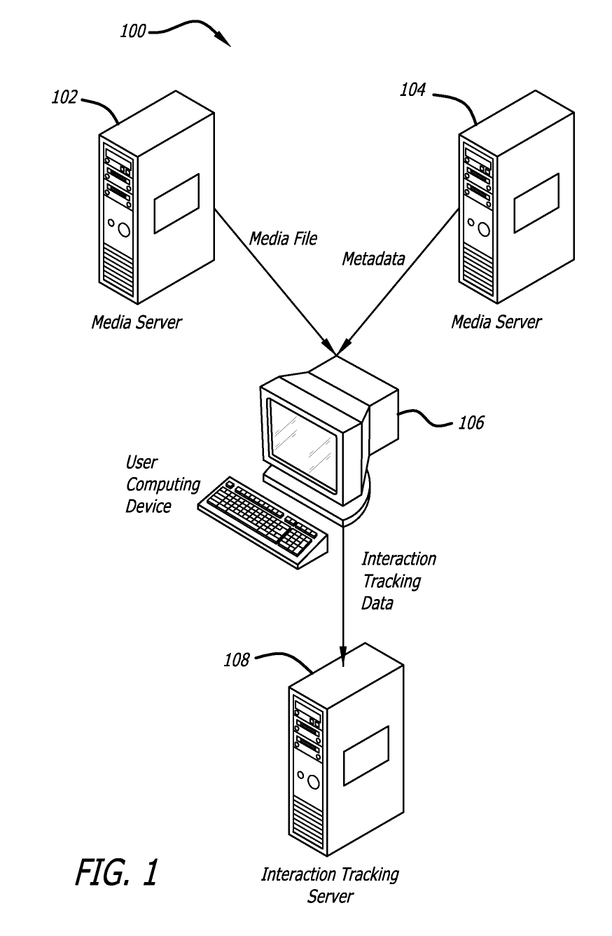

FIG. 1 illustrates an interactive product placement configuration 100. The interactive product placement configuration 100 includes a media server 102, a metadata server 104, a user computing device 106, and an interaction tracking server 108. The media server 102 sends a media file to the user computing device 106. Examples of the media file include, but are not limited to, video and/or audio files. For instance, the media file can be a digital video file for utilization with digital video players. In one embodiment, the metadata is handled independently from the media data content. As a result, the media file may even be utilized with yet unknown formats. Further, in one embodiment, the media file does not necessitate additions or modifications. As a result, a previously existing media file may be utilized with the interactive product placement configuration 100 without any modifications or additions.

The metadata server 104 sends metadata to the user computing device 106. The metadata is a set of parameters that allows processing of user interaction data. The metadata server 104 may send the metadata as a separate file or as a data stream. In one embodiment, the metadata includes a plurality of x and y coordinates that indicate an interactive region of a display of the media file at a predetermined time. For example, the metadata may indicate that the following coordinates define an interactive region of the display of the media file for the first thirty seconds that the media file is played: {(1,500), (100,500), (100, 1500), (1, 1500)}. Accordingly, the polygon defined by these x and y coordinates is the interactive region. For instance, the interactive region may be a polygon that surrounds the shirt of the lead actor for the first five minutes in a user's favorite movie. In one embodiment, the display may have multiple interactive regions in different parts of the display at a given time. Further, in one embodiment, the metadata also includes one or more instructions that are automatically triggered upon user interaction within the interactive region of the display of the media file. For example, the instruction may instruct the user computing device 106 to launch a web browser and connect to the web site of the designer of the lead actor's shirt upon the user rolling a mouse over the interactive region and/or clicking on the interactive region with a mouse pointer.

The user computing device 106 sends interaction tracking data to the interaction tracking server 108. In one embodiment, the interactive region includes an interactive region unique identifier. The interactive region unique identifier is sent to the interaction tracking server 108. The interaction tracking server 108 utilizes the interactive region unique identifier for tracking, analytics, and final redirection to new web pages or services.

In one embodiment, the user computing device 106 has an interactive region monitoring module that monitors the interactive region in the display of the media file at the plurality of x and y coordinates. The one or more instructions from the metadata are provided to the interactive region monitoring module. The interactive region monitoring module triggers the instruction upon user interaction within the interactive region of the display of the media file. In one embodiment, the triggering is automatic. The interactive region monitoring module may be either an addition to an existing media player or as a stand-alone media player. The interactive region monitoring module monitors user interaction with media playback and processes the interaction according to instructions in the accompanying metadata.

The one or more instructions may immediately launch a new web page or service. This configuration may be utilized without the interaction tracking server 108. The one or more instructions simply launch the new service or web page as a direct link. This interaction allows the interactive region monitoring module to exist in more self-contained environments where Internet access may not be available or desired.

Alternatively, the one or more instructions may launch a new web page or service through an external server such as the interaction tracking server 108. Accordingly, the interaction tracking server 108 may perform analytics and dynamic user recommendations. In one embodiment, interaction data and the interactive region unique identifier is sent to the interaction tracking server 108 for processing. The interaction data may include a user's unique identifier, an Internet Protocol (“IP”) address of the user computing device 106 being interacted with, the timer of interaction, the coordinates of a mouse click, and/or information about the user computing device such as size, resolution, processing power, connection speed, etc.

The one or more instructions may also provide a set of menu options once a user interaction is detected. For example, the set of options may include a name option that displays a name of a product available for purchase, a priority option that displays a priority, a web site link option that displays a web site link that corresponds to a web site where a product displayed in the interactive region that is available for purchase, a summary option that displays a summary that corresponds to product information for a product displayed in the interactive region that is available for purchase, a photograph option that displays a photograph that corresponds to a product displayed in the interactive region that is available for purchase, a video option that displays a video that corresponds to a product displayed in the interactive region that is available for purchase, a retailer option that displays retailer information of a retailer that sells a product displayed in the interactive region that is available for purchase, an advertiser option that displays advertiser information of an advertiser that purchased an advertisement displayed with the product displayed in the interactive region that is available for purchase, a creator option that displays creator information of a creator that created a product displayed in the interactive region that is available for purchase, and/or a metadata option that displays metadata specific to a type of product displayed in the interactive region that is available for purchase.

Data may be tracked for analytical purposes. Data specific to a product in the display of a media file may be tracked. For example, the type and/or name of a product, the color and/or style of a product, the time that the product is seen on screen during display of the media file, and the coordinates of the display occupied by the product may be tracked. Data pertinent to the immediate interaction of a user is also trackable. For example, the time at which a user selects an item, the portion of the display click by the user, the method of interaction, the IP address of the computing device 106, and/or the type of the computing device viewing the medial file and associated detail may be tracked.

Data pertinent to the user may be trackable. In one embodiment, data pertinent to the user may be trackable even without a specific account for the user. The data may include other items that the user has previously clicked on, follow-through rate of the user, i.e., the rate at which the user completes transactions, and/or the physical location of the user computing device 106 through IP address detection.

In another embodiment, data pertinent to the user may be trackable if a unique account for the user is active. The information may include personal information included in the account such as name, address, contact information, age, ethnicity, etc. This data may be analyzed to analyze the demographics of people interested in items to help determine how to better build interest in the product.

In one embodiment, a user benefits from his or her information being tracked. A shopping cart feature may be utilized to store items that the user expressed interest in for later viewing. Accordingly, the user may build a list of items without having to interrupt the viewing experience. The data may be gathered to created recommendations for the user, based on previous habits, for both products and media files to watch.

Although different servers are illustrated for the delivery of the media file and the metadata, one server or zero servers may be utilized. For example, a single server may deliver the media file and the metadata independently from one another rather than necessitating that the media file be joined with the metadata. That single server may also be utilized for the interaction tracking. Additionally, the media file may be delivered as a self-contained package which includes the media file and metadata without utilizing different or a single server.

Further, the media file and metadata do not have to be web-based. For example, DVDs, Blue Ray, and other existing or future physical media may be adapted also. A DVD can store the media file and the metadata. Upon interaction with the video, the user can then be sent for the first time to the Internet to track the interaction and redirect him or her to the appropriate web service. Alternatively, the DVD can be utilized without going to the Internet as the system can also launch new videos or services included on the DVD.

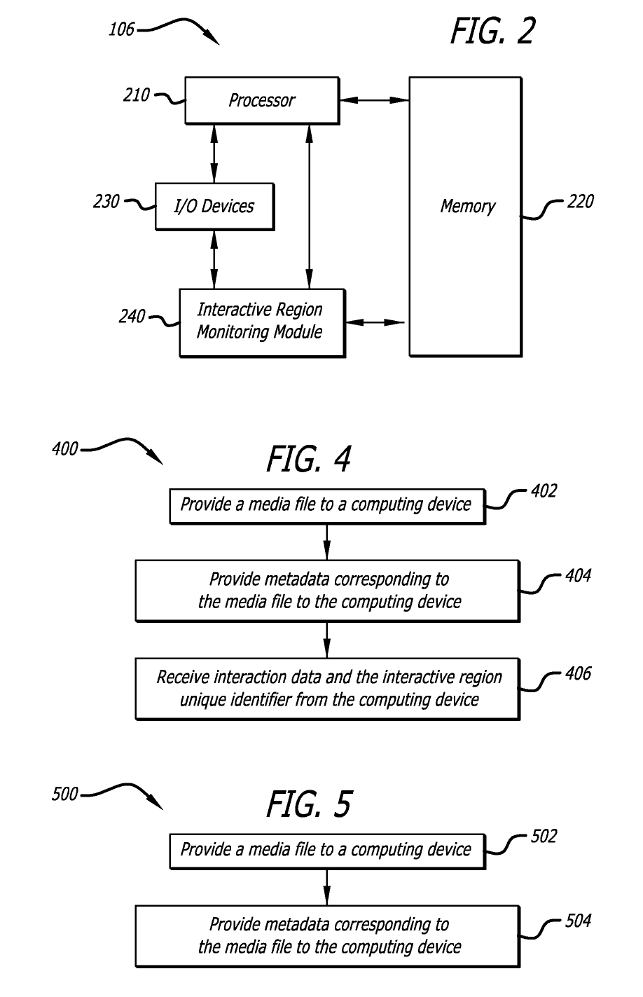

FIG. 2 illustrates a block diagram of the user computing device 106. In one embodiment, the user computing device 106 is implemented utilizing a general purpose computer or any other hardware equivalents. Thus, the user computing device 106 comprises a processor 210, a memory 220, e.g., random access memory (“RAM”) and/or read only memory (ROM), an interactive region monitoring module 240, and various input/output devices 230, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). In one embodiment, a display module determines the display for the input/output devices 230 of the media file and/or the interactive region in the display of the media file at the plurality of x and y coordinates.

It should be understood that the interactive region monitoring module 240 may be implemented as one or more physical devices that are coupled to the processor 210. For example, the interactive region monitoring module 240 may include a plurality of modules. Alternatively, the interactive region monitoring module 240 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 220 of the computer. As such, the interactive region monitoring module 240 (including associated data structures) of the present disclosure may be stored on a computer readable medium, e.g., RAM memory, magnetic or optical drive or diskette and the like.

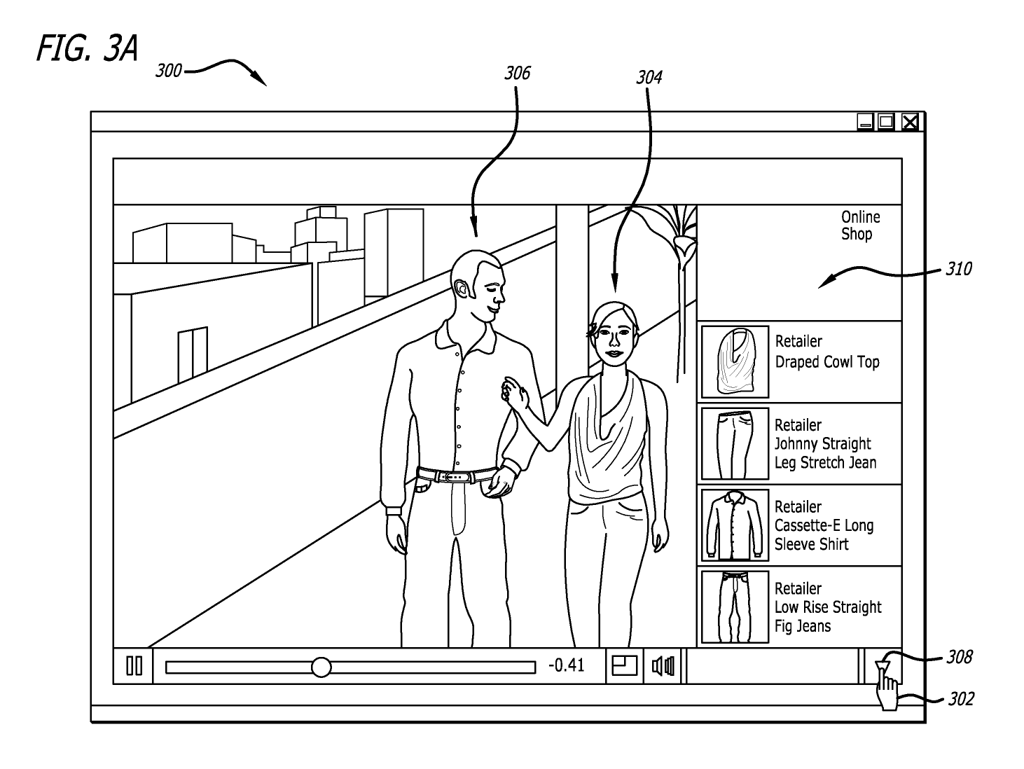

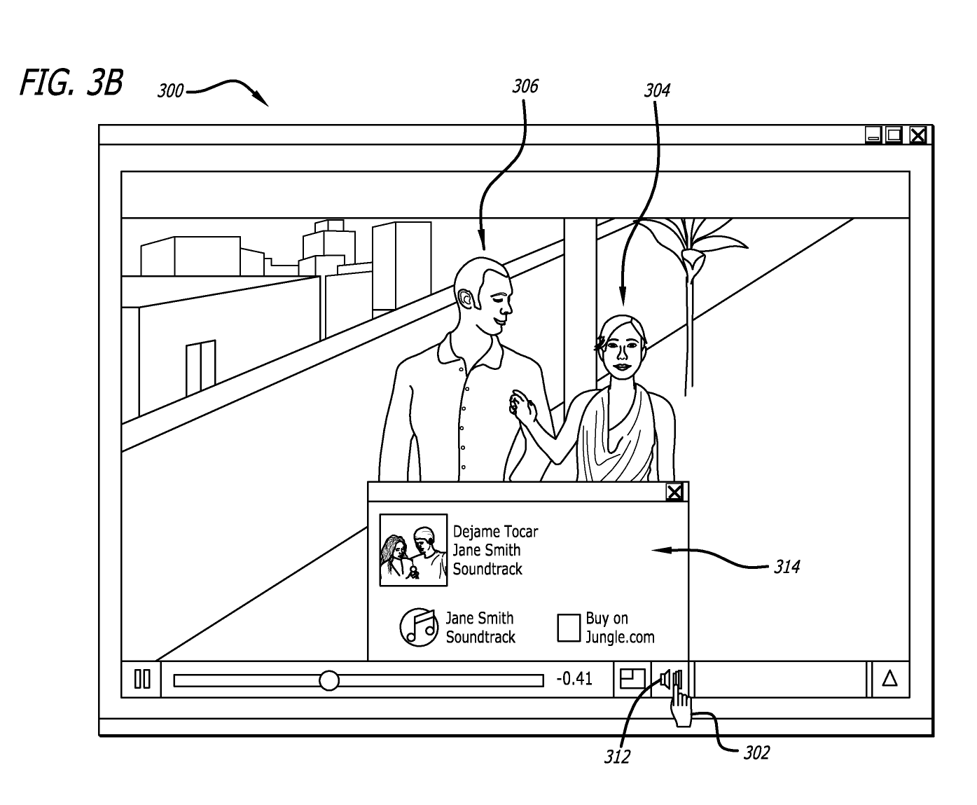

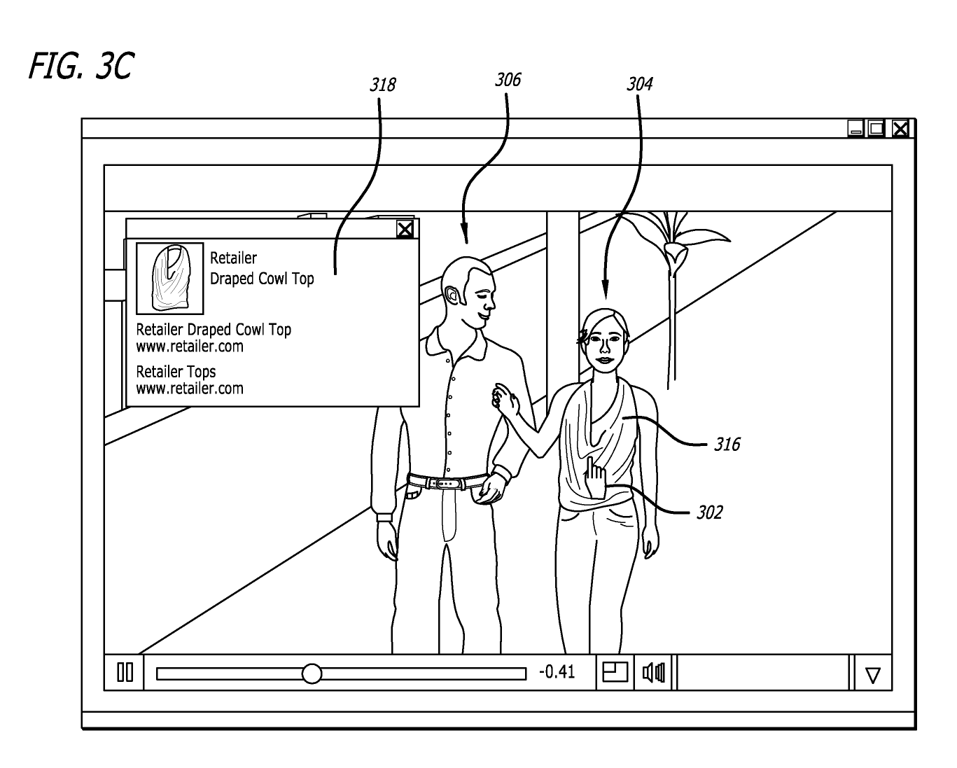

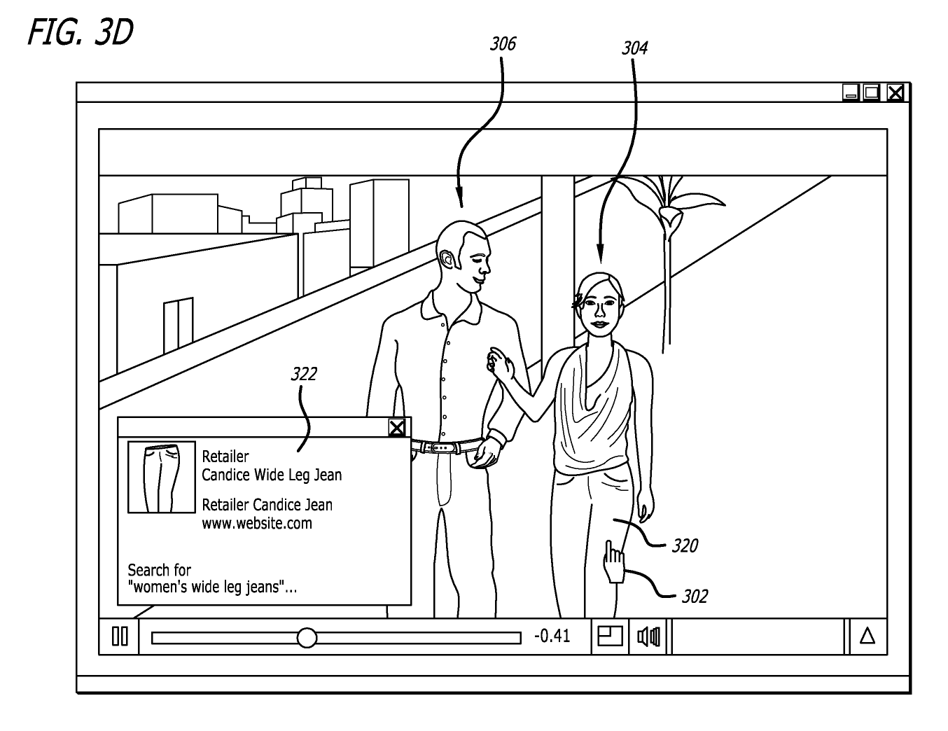

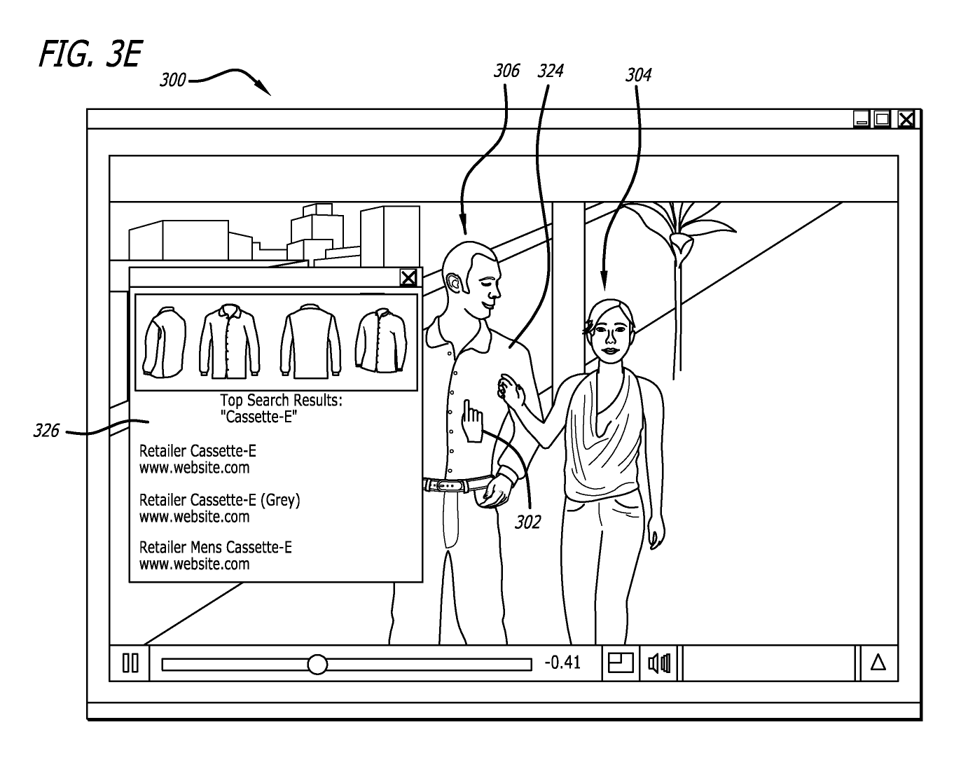

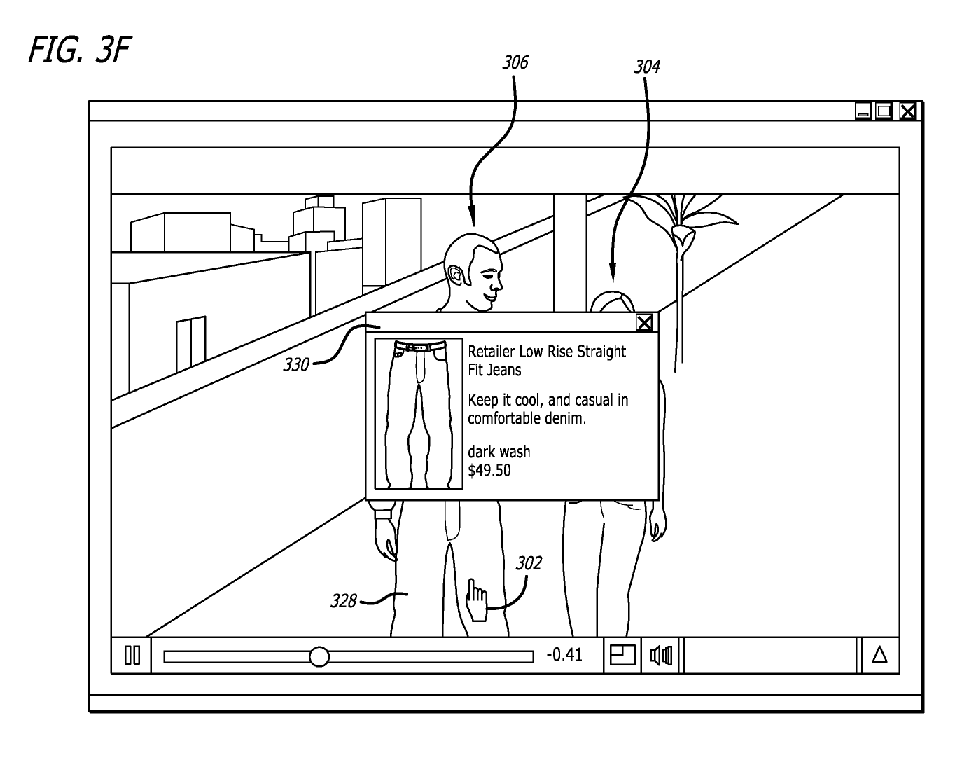

FIGS. 3A-3F illustrate an interactive display 300. FIG. 3A illustrates the interactive display 300 with a menu 310 of available products in the display at a particular time. For example, at forty one percent of the playback of the display 300, a woman 304 and a man 306 are displayed in a scene. The menu 310 displays information about the shirt of the woman 304, the jeans of the woman 304, the shirt of the man 306, and the jeans of the man 306. A cursor 302 may be utilized by the user to select a menu button 308 to display the menu 310. Each menu item may be associated with a link to one or more web sites at which the particular item is available for purchase. At a different time, the menu 310 may indicate different items. For example, at eighty percent of the playback of the display 300, a different person with different items may appear in a scene.

FIG. 3B illustrates the interactive display 300 with a sound window 314. The sound window 314 indicates the background music that is playing in the scene. Further, the sound window 314 may be associated with one or more web sites at which the soundtrack is available for purchase. The cursor 302 may be utilized by the user to select a sound button 312 to display the sound window 314.

FIG. 3C illustrates the interactive display 300 with an interactive region. In this example, the interactive region may be the area of the interactive display 300 that encompasses the shirt 316 of the woman 304. The interactive region may be x and y coordinates of the outline of the shirt 316 or a polygon or other shape that includes the shirt 316. Accordingly, when the user moves the cursor 302 into the interactive region, an interactive region window 318 may be displayed that indicates information about the shirt 316. In another embodiment, the interactive region window 318 is displayed when the cursor 302 is clicked in the interactive region window. The interactive region window 318 may include a link to one or more web sites at which the shirt 316 may be purchased.

FIG. 3D illustrates the interactive display 300 with another interactive region. In this example, the interactive region may be the area of the interactive display 300 that encompasses the jeans 320 of the woman 304. Accordingly, when the user moves the cursor 302 into the interactive region and/or clicks the cursor 302, an interactive region window 322 may be displayed that indicates information about the jeans 320.

FIG. 3E illustrates the interactive display 300 with another interactive region. In this example, the interactive region may be the area of the interactive display 300 that encompasses the shirt 324 of the man 306. Accordingly, when the user moves the cursor 302 into the interactive region and/or clicks the cursor 302, an interactive region window 326 may be displayed that indicates information about the shirt 324.

FIG. 3F illustrates the interactive display 300 with another interactive region. In this example, the interactive region may be the area of the interactive display 300 that encompasses the jeans 328 of the man 306. Accordingly, when the user moves the cursor 302 into the interactive region and/or clicks the cursor 302, an interactive region window 330 may be displayed that indicates information about the jeans 328.

A plurality of interactive regions may be utilized for the different items in the interactive display 300. Each of the interactive regions may be associated with a specific product or service.

Any systems and apparatuses described herein may be implemented in a process. FIG. 4 illustrates a process 400 that may be utilized to provide interactive tracking. At a process block 402, the process 400 provides a media file to a computing device. Further, at a process block 404, the process 400 provides metadata corresponding to the media file to the computing device. The metadata includes (i) a plurality of x and y coordinates that indicate an interactive region of a display of the media file at a predetermined time and (ii) an instruction that is automatically triggered upon user interaction within the interactive region of the display of the media file. The interactive region includes an interactive region unique identifier. In addition, at a process block 406, the process 400 receives interaction data and the interactive region unique identifier from the computing device. The interaction data includes data corresponding to user interaction in the interactive region of the display of the media file. In another embodiment, interaction data without the interactive region unique identifier is received. In yet another, embodiment, the interactive region unique identifier without the interaction data is received.

FIG. 5 illustrates a process 500 that may be utilize to provide interactive tracking. At a process block 502, the process 500 provides a media file to a computing device. Further, at a process block 504, the process 500 provides metadata corresponding to the media file to the computing device. The metadata includes (i) a plurality of x and y coordinates that indicate an interactive region of a display of the media file at a predetermined time and (ii) an instruction that is automatically triggered upon user interaction within the interactive region of the display of the media file. The interactive region includes an interactive region unique identifier.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be a, kiosk, STB, cell phone, PMP, gaming device or the like.

A web service or a web page may be launched as a result of user interaction to allow a user to purchase an item. Further, a Digital Video Recorder (“DVR”) with the interactive region monitoring module may enable viewers to purchase products on televisions networks directly through existing accounts. In addition, handheld video players may process interaction with video podcasts allowing purchases through existing accounts of items in the video. Checkout kiosks in retail stores may be retrofitted to play a video allowing last minute purchase in the checkout line. In particular, items such as extended warranties or preorders that may be difficult to promote may be displayed in the video.

In one embodiment, a running ticker of items that are available for interaction in the video is displayed. Accordingly, the user may turn on some sort of visual and/or audio display of items that he or she may have missed in the media file. This feature may be helpful with an audio file. The ticker may be selected from a variety of formats including, but not limited to, a vertically scrolling list, a horizontally scrolling list, a single region of the screen that continually updates with each new item, a popup type indicator of interactive regions, visual highlighting of interactive regions as they appear, visual tickers on secondary devices like remote controls allowing the primary video area to be uncluttered, a ticker outside the standard video are on the computer interface, a list in a separate application on a computer that tracks items from all videos watched rather than just the current video, voice or other audio-based indicators, and lists stored on external websites of items that the user has viewed.

With respect to content management, the metadata about the items in the media file has to be initially created. In one embodiment, the interactive regions are defined manually over a series of frames. In another embodiment, hardware and/or software may be implemented to automatically identify the products/items to be interacted with. An item may be selected by a content manager within a single frame of a video so that both the physical interactive region of the item in that given frame and other frames before and after may be extrapolated by the hardware and/or software. As a result, the metadata is created faster.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes and systems. Therefore, it is to be understood that, within the scope of the appended claims, the present processes and systems may be practiced other than as specifically described herein.

We claim:

1. A system comprising:
a media server that provides a media file to a computing device;
a metadata server that provides metadata corresponding to the media file to the computing device, the metadata including (i) a plurality of x and y coordinates that indicate an interactive region of a display of the media file at a predetermined time and (ii) an instruction that is automatically triggered upon user interaction within the interactive region of the display of the media file, the interactive region including an interactive region unique identifier; and
an interaction tracking server that receives interaction data and the interactive region unique identifier from the computing device, the interaction data including data corresponding to user interaction in the interactive region of the display of the media file.

2. The system of claim 1, wherein the interaction tracking server launches a web page including data corresponding to the interactive region of the display of the media file.

3. The system of claim 1, wherein the user interaction is a mouse cursor placed over an image in the interactive region of the display of the media file.

4. The system of claim 3, wherein the image is a product available for purchase.

5. The system of claim 4, wherein the interaction tracking server launches a web page that processes purchase of the product.

6. The system of claim 5, wherein the interactive region unique identifier is associated with the web page.

7. The system of claim 6, wherein the interaction tracking server utilizes the interactive region unique identifier to identify the web page.

8. The system of claim 1, wherein the user interaction is a selection of a menu option from a menu presented to a user after a mouse cursor is placed over an image in the interactive region of the display of the media file.

9. The system of claim 8, wherein the menu option is a name option that displays a name of a product available for purchase.

10. The system of claim 8, wherein the menu option is a priority option that displays a priority.

11. The system of claim 8, wherein the menu option is a web site link option that displays a web site link that corresponds to a web site where a product displayed in the interactive region that is available for purchase.

12. The system of claim 8, wherein the menu option is a summary option that displays a summary that corresponds to product information for a product displayed in the interactive region that is available for purchase.

13. The system of claim 8, wherein the menu option is a photograph option that displays a photograph that corresponds to a product displayed in the interactive region that is available for purchase.

14. The system of claim 8, wherein the menu option is a video option that displays a video that corresponds to a product displayed in the interactive region that is available for purchase.

15. The system of claim 8, wherein the menu option is a retailer option that displays retailer information of a retailer that sells a product displayed in the interactive region that is available for purchase.

16. The system of claim 8, wherein the menu option is an advertiser option that displays advertiser information of an advertiser that purchased an advertisement displayed with the product displayed in the interactive region that is available for purchase.

17. The system of claim 8, wherein the menu option is a creator option that displays creator information of a creator that created a product displayed in the interactive region that is available for purchase.

18. The system of claim 8, wherein the menu option is a metadata option that displays metadata specific to a type of product displayed in the interactive region that is available for purchase.

19. The system of claim 1, wherein the media file is a video file.

20. The system of claim 1, wherein the media file is an audio file.

21. The system of claim 1, wherein the interaction tracking server also receives, from the computing device, a unique identifier of a user.

22. The system of claim 1, wherein the interaction tracking server also receives, from the computing device, an Internet Protocol address of the computing device.

23. The system of claim 1, wherein the interaction tracking server also receives, from the computing device, a time of user interaction with the computing device.

24. The system of claim 1, wherein the interaction tracking server also receives, from the computing device, a set of coordinates of a mouse click in the interactive region of the display of the media file.

25. The system of claim 1, wherein the interaction tracking server stores user data.

26. The system of claim 1, wherein the interaction tracking server stores analytics.

27. The system of claim 1, wherein the computing device is a computer.

28. The system of claim 1, wherein the computing device is a cell phone.

29. The system of claim 1, wherein the computing device is a personal media player.

30. The system of claim 1, wherein the computing device is a set top box.

31. The system of claim 1, wherein the computing device is a gaming device.

32. A system comprising:
a media server that provides a media file to a computing device; and
a metadata server that provides metadata corresponding to the media file to the computing device, the metadata including (i) a plurality of x and y coordinates that indicate an interactive region of a display of the media file at a predetermined time and (ii) a plurality of instructions that are automatically triggered upon user interaction within the interactive region of the display of the media file, the interactive region including a unique identifier.

33. The system of claim 32, wherein the computing device launches a web page including data corresponding to the interactive region of the display of the media file.

34. The system of claim 32, wherein the user interaction is a mouse cursor placed over an image in the interactive region of the display of the media file.

35. The system of claim 34, wherein the image is a product available for purchase.

36. An apparatus comprising:
a media file reception module that receives a media file;
a metadata reception module that receives metadata corresponding to the media file to the computing device, the metadata including (i) a plurality of x and y coordinates that indicate an interactive region of a display of the media file at a predetermined time and (ii) an instruction that is automatically triggered upon user interaction within the interactive region of the display of the media file, the interactive region including an interactive region unique identifier;
a display module that provides a display of the media file and the interactive region in the display of the media file at the plurality of x and y coordinates;
an interactive region monitoring module that monitors the interactive region in the display of the media file at the plurality of x and y coordinates; and
an interaction data transmission module that transmits interaction data and the interactive region unique identifier to an interaction tracking server, the interaction data including data corresponding to user interaction in the interactive region of the display of the media file.

37. The apparatus of claim 36, wherein the interaction tracking server launches a web page including data corresponding to the interactive region of the display of the media file.

38. The system of claim 36, wherein the user interaction is a mouse cursor placed over an image in the interactive region of the display of the media file.

39. The system of claim 36, wherein the image is a product available for purchase.

40. An apparatus comprising:
a media file reception module that receives a media file;
a metadata reception module that receives metadata corresponding to the media file to the computing device, the metadata including (i) a plurality of x and y coordinates that indicate an interactive region of a display of the media file at a predetermined time and (ii) an instruction that is automatically triggered upon user interaction within the interactive region of the display of the media file, the interactive region including an interactive region unique identifier;
a display module that provides a display of the media file and the interactive region in the display of the media file at the plurality of x and y coordinates; and
an interactive region monitoring module that monitors the interactive region in the display of the media file at the plurality of x and y coordinates.

41. The apparatus of claim 40, wherein the computing device launches a web page including data corresponding to the interactive region of the display of the media file.

42. The apparatus of claim 40, wherein the user interaction is a mouse cursor placed over an image in the interactive region of the display of the media file.

43. The apparatus of claim 42, wherein the image is a product available for purchase.
